(19) United States
(12) Patent Application Publication
(10) Pub. No.: US 2015/0020165 A1
(43) Pub. Date: Jan. 15, 2015

(54) SYSTEM OF EXECUTING APPLICATION AND METHOD THEREOF

(71) Applicants: INVENTEC CORPORATION, Taipei (TW); INVENTEC (PUDONG) TECHNOLOGY CORPORATION, Shanghai (CN)

(72) Inventor: Sean LIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 14/206,656

(22) Filed: Mar. 12, 2014

(30) Foreign Application Priority Data
Jul. 9, 2013 (CN) 201310287504.1

(51) Int. Cl. G06F 21/32

(52) U.S. Cl. CPC G06F 21/32
USPC 726/4

(57) ABSTRACT

An application executing system and a method thereof are provided. When an application in an electronic device is executed, identification information is received for identification, and physiological characteristic information is further gathered. User access permission is given when the identification information and default identification information are compared to be in consistency. User edit permission is given when the physiological characteristic information and default physiological characteristic information are compared to be in consistency. When the application is executed, functions of the application are provided to be used according to the access permission or the edit permission. Therefore, providing different functions of the application according to different permissions may be achieved.

### BACKGROUND OF THE INVENTION

1. Field of Invention

The present invention is related to an application execution system and a method thereof, and particularly to an application execution system and a method thereof, which may provide different functions according to different permissions.

2. Description of Related Art

In an electronic device, a screen locking function is used for information security and avoiding improper operated, etc, and in order to protect the information.

Screen locking functions contain two, one has login screen and one has no login screen. For which has login screen, and the screen turns to unlock by inputting a password preset by a user of the electronic device. For which has no login screen, the screen turns to unlock by inputting a particular key-in combination.

However, such screen locking techniques only provide basic information security. When the password leaking, the screen locking may unlock easily by others. In this case, all applications in the electronic device may be executed and information stored may be stolen, it will cause information security problem

In view of the above, information security is a long existing problem for such screen locking functions of electronic devices. Therefore, it is quite a need to change such situation encountered in the prior art.

### SUMMARY OF THE INVENTION

It is, therefore, an object of the present invention to provide a system of executing an application applied on an electronic device with at least an application, comprising: a storing module, setting and storing a default permission information and at least one default physiological characteristic information in the electronic device; an operating interface module, providing an operating interface when the application is selected, and generating a permission information according to an input information received through the operating interface; a physiological information collection module, gathering a user physiological characteristic information while receiving the input information; a first authentication module, granting a access permission with input information when the permission information and the default permission information are consistent; a second authentication module, granting an edit permission to the user when the physiological characteristic information and the default physiological characteristic information are consistent, while granting the access permission to the user when the physiological characteristic information and the default physiological characteristic information are different; and an execution module, executing corresponding function of the application according to the one of the access permission or the edit permission.

It is another object of the present invention to provide a method of executing an application applied on an electronic device with at least an application, comprising steps of: setting and storing a default permission information and at least one default physiological characteristic information in the electronic device; providing an operating interface when the application is selected, and generating a permission information according to an input information received through the operating interface; granting an access permission associated with the input information when the permission information and the default permission information are consistent; gathering the physiological characteristic information while receiving the input information; granting an edit permission when the physiological characteristic information and the default physiological characteristic information are consistent, while granting the access permission when the physiological characteristic information and the default physiological characteristic information are different; and executing corresponding function of the application according to the access permission or the edit permission.

In order to make the aforementioned and other features and advantages of the invention comprehensible, several exemplary embodiments accompanied with figures are described in detail below.

### BRIEF DESCRIPTION OF THE DRAWINGS

The objects and advantages of the present invention will become more apparent from the detailed description of the embodiment of the invention when read in conjunction with the accompanying drawing, and wherein:

FIG. 1 illustrates a block diagram of a system of executing an application of the present invention;

FIG. 2 illustrates a process flow of a method of executing an application of the present invention;

FIG. 3 illustrates a operation interface diagram of an application execution task of the present invention;

FIG. 4A illustrates a default physiological characteristic information of an application execution task of the present invention;

FIG. 4B illustrates a physiological characteristic information of an application execution task of the present invention;

FIG. 4C illustrates a physiological characteristic information of an application execution task according to the present invention;

FIG. 5A illustrates a application display of an application execution task of the present invention; and

FIG. 5B illustrates an application edit display of an application execution task of the present invention.

### DETAILED DESCRIPTION OF THE INVENTION

The present invention will be apparent from the following detailed description, which proceeds with reference to the accompanying drawings, wherein the same references relate to the same elements. With reference to the detailed description, those skilled in the art may use the technical skill to solve the associated problem and thus achieve in the technical efficacy associated therewith, namely, may be enabled to implement the present invention.

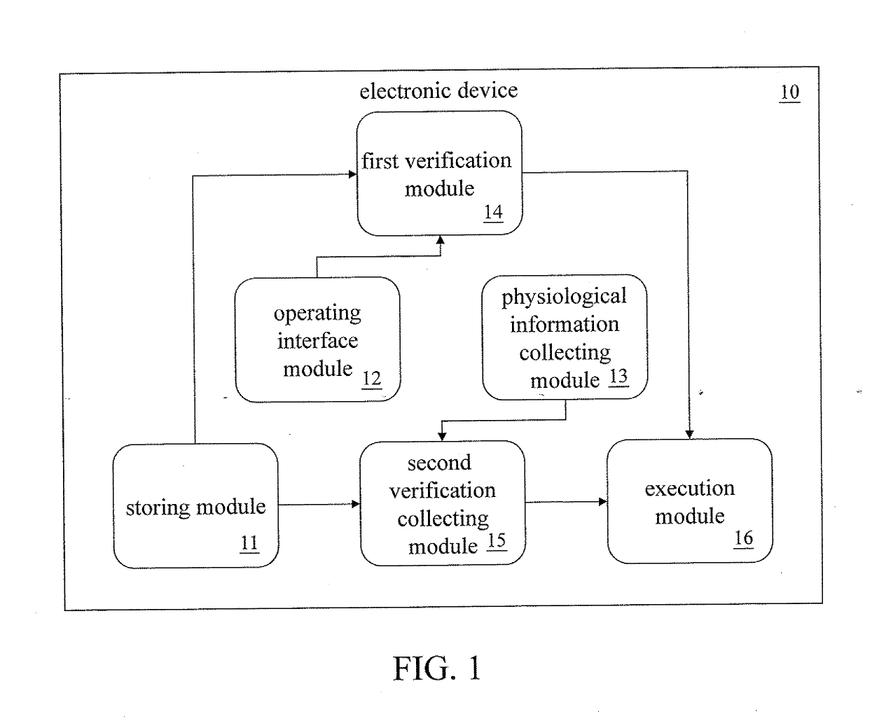

Now, the disclosed system in the present invention will be described. Referring to FIG. 1 first, in which a block diagram of the system according to the present invention is described. The application execution system comprises a storing module 11, an operating interface module 12, physiological information module 13, a first authentication module 14, a second authentication module 15 and an execution module 16.

The system of executing an application is applied to an electronic device 10, which may be a tablet computer, a notebook computer, a smart mobile phone, etc, which are only examples, not to limit the present invention. The storing module 11 of the electronic device 10 is used to set and store default permission information and at least default physiological characteristic information in the electronic device 10. The default permission information may be a character, number, symbol and their combinations (user name and password, authentication code and authentication characters, etc.), or a picture frame, which are only examples, not to limit the present invention. The default physiological characteristic information may be a waveform characteristic of a sound, a fingerprint characteristic of a fingerprint, an iris texture characteristic of an iris, a retina texture of a retina, which are only examples, not to limit the present invention.

When a user selects one of the applications existing in the electronic device 10, the operating interface module 12 of the electronic device 10 provides an operating interface, on which the user may input a character, number, symbol, sound, picture frame or bar code, etc., which are only examples, not to limit the present invention. When the operating interface module 12 receives the input character, number, symbol or picture frame, permission information is directly generated according thereto. Specifically, when the input content is a sound, the operating interface module 12 generates the permission information by using a sound to character conversion technique. When the input content is a bar code, including a one dimension and a two dimension bar codes, the permission information is generated by using a bar code decoding technique.

In the electronic device 10, when the operating interface module 12 receives the input content, the physiological information collecting module 13 collects physiological characteristic information of the user. The physiological characteristic information includes a waveform characteristic of a sound from the user, a fingerprint characteristic of a fingerprint of the user, an iris characteristic of an iris of the user, and a retina characteristic of a retina of the user. But, these physiological characteristics are only examples, not to limit the present invention.

In the electronic device 10, after the operating interface module 12 generates the permission information, the first authentication module 14 compares the permission information and the default permission information. When the permission information and the default permission information are consistent, the user has the access permission.

After the physiological information of the user is gathered by the physiological information collecting module 13, the second authentication module 15 compares the physiological characteristic information and the default physiological characteristic information. When the physiological characteristic information and the default physiological characteristic information are consistent, the user has the edit permission.

In the electronic device 10, after the first and second authentication modules 14, 15 give the access or edit permission, the execution module 16 executes the application corresponding thereto. When the permission given is the access permission, the user is provided with the access functions associated with the application, such as drag and roll, zoom in and zoom out, rotation. On the other hand, when the permission given to the user is the edit permission, the user is provided with edit functions associated with the application, such as addition, delete, remark and depiction. But these access and edit permissions are only exemplified, not to be used as a limitation.

As such, the system will generate different permissions according to different information input, in order to ensure the information of the application security.

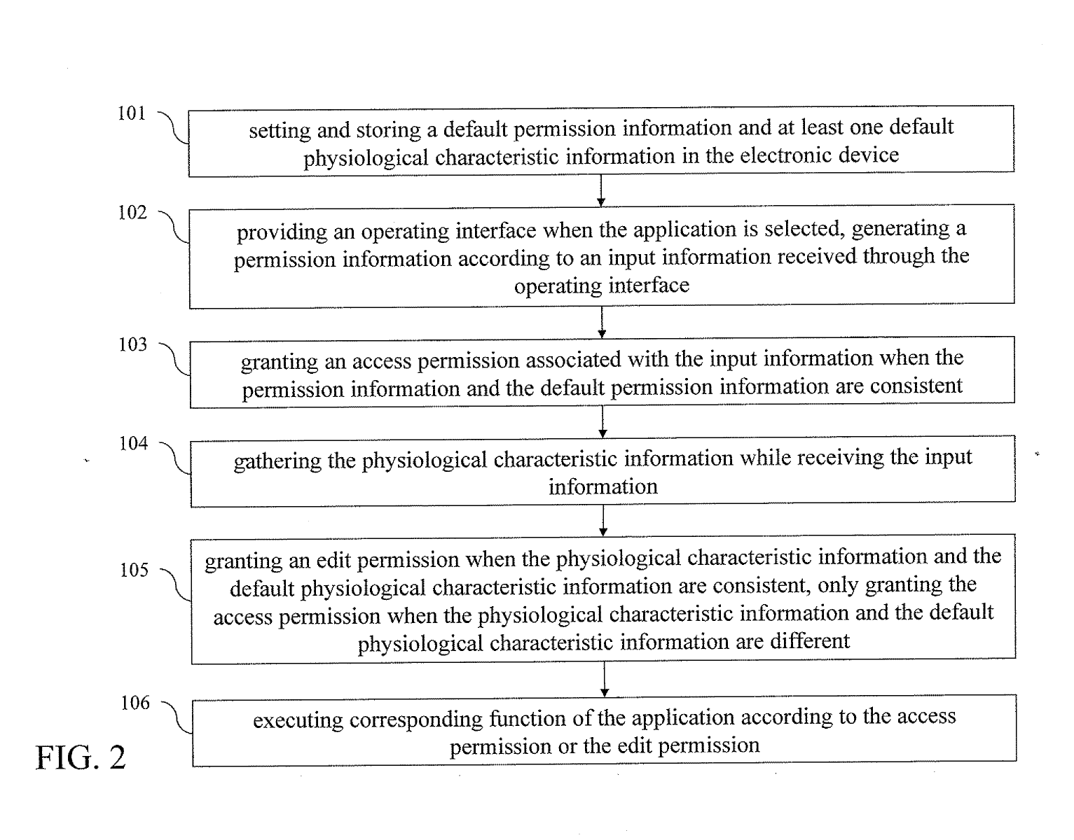

Now, the disclosed application execution method in the present invention will be described with reference to FIG. 1 and FIG. 2, wherein FIG. 2 is a process flow of the method of executing an application according to the present invention.

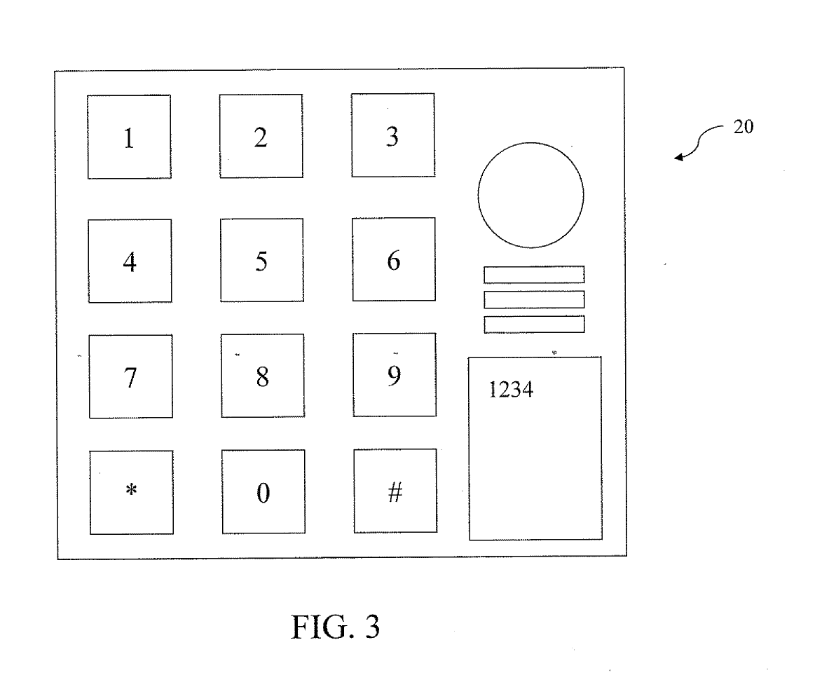

Referring to FIG. 3, it illustrates an operation interface diagram of an application execution task according to the present invention.

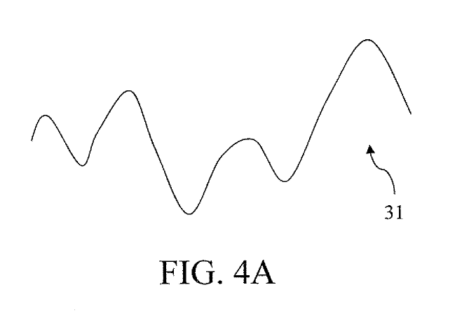

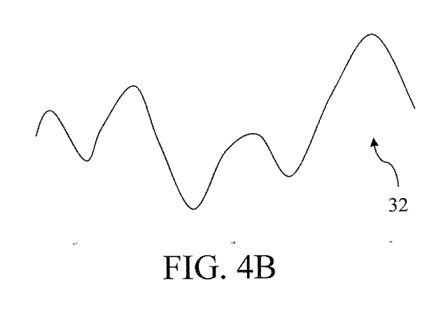

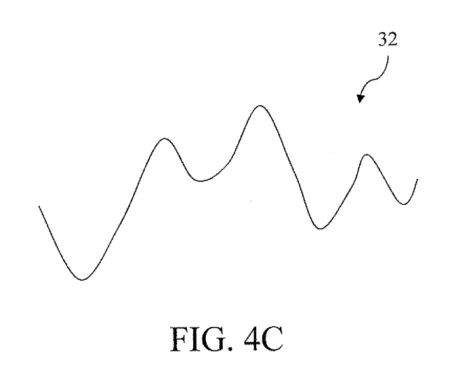

The application execution system is applied onto an electronic device 10, which may be a tablet computer, a notebook computer, a smart mobile phone, etc, which are only examples, not to limit the present invention. The storing module 11 of the electronic device 10 is used to pre-store default permission information “1234” (the set and stored authentication information is the authentication code, which is only an example, not to limit the present invention) and pre-set the physiological characteristic information 31 in the electronic device 10. Referring to FIG. 4A and FIG. 4B, diagrams of the default physiological characteristic information executed by the application according to the present invention are respectively shown therein. The default physiological characteristic information 31 is the waveform characteristic of a sound, which is only an example, not to limit the present invention (S101).

When the user activates one of the applications in the electronic device 10, the operating interface module 12 provides an operating interface 20. On the operating interface 20, the user may input numbers “1234”. As receiving the input content “1234”, the system generates permission information “1234” (S102).

Referring to FIG. 4B, when the operating interface module 12 receives the input content, the physiological information collecting module 13 gathers the physiological characteristic information 32 of the user at the same time. Namely, the physiological information collecting module 13 identifies the sound waveform characteristic to gather the physiological characteristic information 32 of the user (S104).

In the electronic device 10, after the operating interface module 12 generates the permission information “1234”, the first authentication module 14 compares the permission information “1234” and the default permission information “1234”. In this embodiment, the permission information is “1234” and the default permission information is “1234” are consistent at the first authentication module 14, and then the user have the access permission (S103).

Referring to FIG. 4A and FIG. 4B concurrently, the physiological information collecting module 13 collects the physiological character information 32 (S104), and then the second authentication module 15 compares the physiological character information 32 and the default physiological characteristic information 31. In this embodiment, the physiological characteristic information 32 and the default physiological information 31 are consistent, and the user has the edit permission (S105).

Referring to FIG. 4A and FIG. 4C concurrently, in which FIG. 4C is a diagram of the physiological character information executed by the application according to the present invention, the physiological information collecting module 13 gathers the physiological character information 32, and then the second authentication module 15 compares the physiological character information 32 and the default physiological characteristic information 31. In this embodiment, the physiological characteristic information 32 and the default physiological information 31 are different, and the user have the access permission (S106).

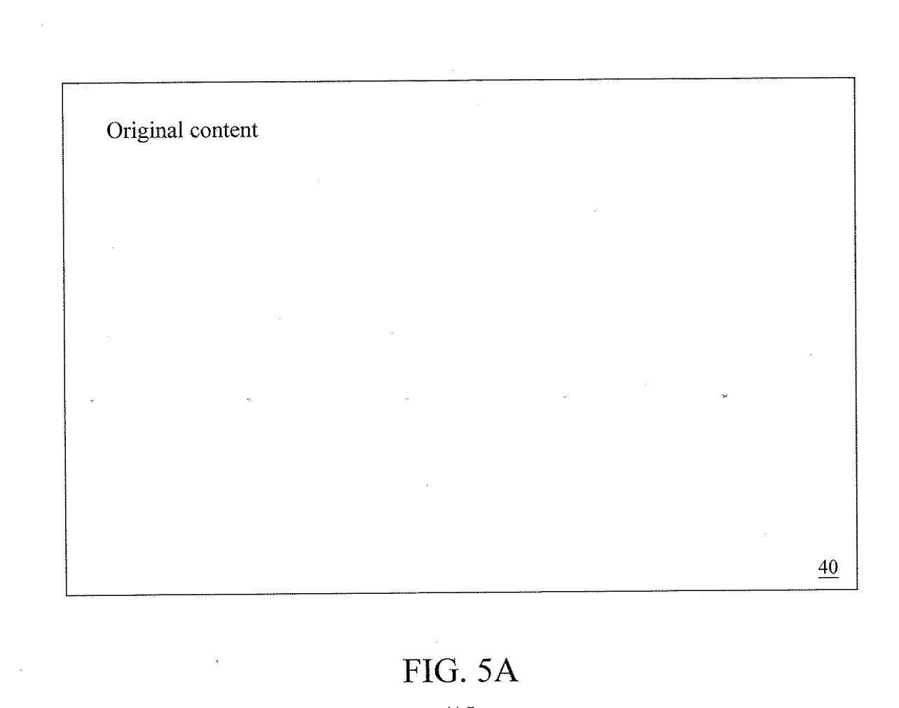

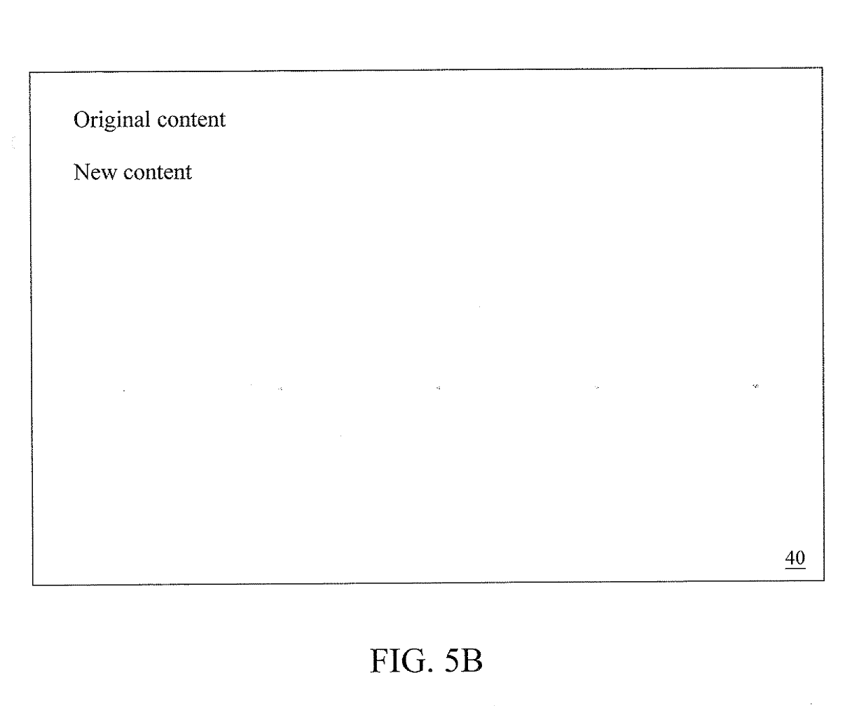

Now referring to FIG. 5A and FIG. 5B, where FIG. 5A illustrates an application display of an application execution task according to the present invention. FIG. 5B illustrates an application edit display of an application execution task according to the present invention.

For the application 40, the first authentication nodules 14 and second authentication modules 15 generate the edit permission , as shown in FIG. 5B, such as addition, delete, remark and depiction, etc. But these edit functions are only exemplified, not to be used as a limitation.

As such, the system will generate different permissions according to different information input, in order to ensure the information of the application security.

In view of the above, the main technical difference as compared to the prior art dwells in that besides the input content by the user for the information authentication in activation of an application in an electronic device, the physiological characteristic information of the user is further gathered. When the permission information and the default permission information are consistent, the user has access permission. When the physiological information and the default physiological information are consistent, the user has edit permission to the application.

By means of the technical content, the shortcomings existing in the prior art where only screen locking is used for safety authentication and information protection for an electronic device may be well overcome, and thus enabling the state providing different functions according to different permissions to be possible.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system of executing an application applied on an electronic device with at least an application, comprising:
a storing module, setting and storing a default permission information and at least one default physiological characteristic information in the electronic device;
an operating interface module, providing an operating interface when the application is selected, and generating a permission information according to input information received through the operating interface;
a physiological information collection module, gathering a user physiological characteristic information while receiving the input information;
a first authentication module, granting a access permission with the input information when the permission information and the default permission information are consistent;
a second authentication module, granting an edit permission to the user when the physiological characteristic information and the default physiological characteristic information are consistent, only granting the access to permission when the physiological characteristic information and the default physiological characteristic information are different; and
an execution module, executing corresponding function of the application according to the access permission or the edit permission.

2. The system according to claim 1, generating the permission information when input information is a sound, wherein the system convert sound character into text character, directly generates the permission information of an image version when input information is an image, and generates the permission information through a bar code decoding technique when input information is a bar code.

3. The system according to claim 1, wherein the physiological characteristic information is gathered by the physiological information collection module by identifying a characteristic selected from a group consisting of: a waveform characteristic of the sound a fingerprint characteristic of a fingerprint, an iris characteristic of an iris texture, and a retina characteristic of a retina texture.

4. The system according to claim 1, wherein the application is locked, the default permission information is unlocking information for the application.

5. The system according to claim 1, wherein when the permission information and the default permission information are consistent, the system will compare if the physiological characteristic information and the default physiological characteristic information are consistent.

6. A method of executing an application applied on an electronic device with at least an application, comprising steps of:
setting and storing a default permission information and at least one default physiological characteristic information in the electronic device;
providing an operating interface when the application is selected, generating a permission information according to input information received through the operating interface;
granting an access permission associated with the input information when the permission information and the default permission information are consistent;
gathering the physiological characteristic information while receiving the input information;
granting an edit permission when the physiological characteristic information and the default physiological characteristic information are consistent, only granting the access permission when the physiological characteristic information and the default physiological characteristic information are different; and
executing corresponding function of the application according to the access permission or the edit permission.

7. The method according to claim 6, wherein the permission information is generated by using a sound to character conversion technique when input information is a sound, generated by the permission information of an image version when input information is an image, and generated by the permission information through a bar code decoding technique when input information is a bar code.

8. The according to claim 6, wherein the physiological characteristic information is gathered by identifying a characteristic selected from a group consisting of: a waveform characteristic of the sound, a fingerprint characteristic of a fingerprint, an iris characteristic of an iris texture, and a retina characteristic of a retina texture.

9. The method according to claim 6, wherein the application is locked, the default permission information is unlocking information for the application.

10. The method according to claim 6, wherein when the permission information and the default permission information are consistent, the application execution system will compare if the physiological characteristic information and the default physiological characteristic information are consistent.
